(19) United States
(12) Patent Application Publication
(10) Pub. No.: US 2015/0303520 A1
(43) Pub. Date: Oct. 22, 2015

(54) NON-AQUEOUS ELECTROLYTE SECONDARY CELL

(71) Applicant: SANYO ELECTRIC CO., LTD., Daito-shii, Osaka (JP)

(72) Inventors: Atsushi Kaiduka, Tokushima (JP); Masato Iwanaga, Tokushima (JP)

(73) Assignee: SANYO ELECTRIC CO., LTD., Daito-shi, Osaka (JP)

(21) Appl. No.: 14/432,857

(22) PCT Filed: Oct. 23, 2013
(86) PCT No.: PCT/JP2013/006252

§ 371 Date: Apr. 1, 2015

(30) Foreign Application Priority Data
Oct. 30, 2012 (JP) 2012-238765

(51) Int. Cl. H01M 10/0569; H01M 4/525; H01M 4/38; H01M 10/0525

(52) U.S. Cl. CPC H01M 10/0569; H01M 10/0525; H01M 4/525; H01M 4/386; H01M 2300/0034; H01M 2004/027

(57) ABSTRACT

A nonaqueous electrolyte secondary battery according to one aspect of the present invention has a positive electrode including a positive electrode active material which absorbs and releases lithium ions, a negative electrode including a negative electrode active material which absorbs and releases lithium ions, a separator, and a nonaqueous electrolyte. The positive electrode active material includes a lithium cobalt composite oxide containing at least aluminum (Al) and magnesium (Mg), the negative electrode active material includes at least one of metal silicon (Si) and a silicon oxide represented by SiOₓ (0.5≦x<1.6), and the nonaqueous electrolyte contains as a nonaqueous solvent, ethylene carbonate, a lactone, and fluoroethylene carbonate.

### TECHNICAL FIELD

The present invention relates to a nonaqueous electrolyte secondary battery having excellent battery characteristics even when a charge end voltage is increased.

### BACKGROUND ART

As drive power sources of mobile electronic apparatuses, such as a mobile phone including a smart phone, a mobile computer, a PDA, and a mobile music player, many nonaqueous electrolyte secondary batteries represented by a lithium ion battery have been widely used. Furthermore, many nonaqueous electrolyte secondary batteries have started to be used as power sources of electric vehicles (EV) and hybrid electric vehicles (HEV and PHEV) and also in stationary storage battery systems used, for example, for application to reduce the variation in output of solar energy generation, wind energy generation, and the like, and peak-shift application of system power control in which an electric power is stored during nighttime and is consumed during daytime.

In particular, since having various battery characteristics superior to those of other materials, a lithium cobalt composite oxide (LiCoO₂) and a foreign element-added lithium cobalt composite oxide in which Al, Mg, Ti, Zr, and/or the like is added have been widely used. However, cobalt is an expensive element, and in addition, the abundance thereof as the natural resource is very limited. Hence, in order to continuously use those lithium cobalt composite oxide and foreign element-added lithium cobalt composite oxide as a positive electrode active material of a nonaqueous electrolyte secondary battery, further improvement in performance thereof has been strongly desired.

As one method for improving the performance of a nonaqueous electrolyte secondary battery which uses a lithium cobalt composite oxide and/or a foreign element-added lithium cobalt composite oxide, there has been known a method in which a charge end voltage with reference to lithium is increased from 4.3 V, which is a generally used potential, to approximately 4.6 V. For example, according to the following Patent Document 1, in a nonaqueous electrolyte secondary battery in which a mixture of a foreign element-added lithium cobalt composite oxide in which Zr and Mg are added and a cobalt-containing layered lithium nickel manganese composite oxide is used as the positive electrode active material, graphite is used as a negative electrode active material, and as a nonaqueous solvent of a nonaqueous electrolyte, a solvent is used which is prepared by further adding vinylene carbonate (VC) to a mixed solvent containing ethylene carbonate (EC), diethyl carbonate (DEC), and methyl ethyl carbonate (MEC), the example in which the charge end voltage is set to 4.4 to 4.6 V with reference to lithium has been disclosed.

According to the following Patent Document 2, in a nonaqueous electrolyte secondary battery in which a mixture of a cobalt-containing layered lithium nickel manganese composite oxide and a lithium cobalt composite oxide containing at least both of zirconium and magnesium is used as the positive electrode active material, graphite is used as the negative electrode active material, and as the nonaqueous solvent of the nonaqueous electrolyte, a solvent is used which contains fluoroethylene carbonate (FEC) and dimethyl carbonate (DMC) and which further contains VC, 2-(methanesulfonyloxy)propionic acid 2-propynyl, and the like, the example in which the charge end voltage is set to 4.4 to 4.6 V with reference to lithium has been disclosed.

According to the following Patent Document 3, in a nonaqueous electrolyte secondary battery in which a mixture of a cobalt-containing layered lithium nickel manganese composite oxide and a lithium cobalt composite oxide containing as a foreign element, magnesium, aluminum, and zirconium is used as the positive electrode active material, graphite is used as the negative electrode active material, and as the nonaqueous solvent of the nonaqueous electrolyte, a solvent is used which contains fluoroethylene carbonate (FEC), propylene carbonate (PC), and MEC and which further contains VC, adiponitrile, and pimelonitrile, the example in which the charge end voltage is set to 4.4 V with reference to lithium has been disclosed.

As described above, as the negative electrode active material of the nonaqueous electrolyte secondary battery, many carbon materials, such as graphite, have been used. However, when a negative electrode active material formed from a carbon material is used, lithium can only be inserted to form a composition of LiC₆, and the theoretical capacity thereof can only be increased to at most 372 mAh/g; hence, the increase in battery capacity is inhibited. Accordingly, a nonaqueous electrolyte secondary battery has been developed in which a silicon oxide and silicon or a silicon alloy forming an alloy with lithium are used as a negative electrode active material having a high energy density per unit mass and per unit volume. For example, since lithium can be inserted into silicon to form a composition of up to Li_{4.4}Si, the theoretical capacity can be increased to 4,200 mAh/g, and compared to the case in which a carbon material is used as the negative electrode active material, a significantly large capacity can be anticipated.

According to the following Patent Document 4, a nonaqueous electrolyte secondary battery has been disclosed in which as the negative electrode active material, a negative electrode active material mixture layer containing graphite and a material which contains silicon and oxygen as constituent elements (however, as an element ratio x of oxygen to silicon, 0.5≦x≦1.5 holds) is used, and in which when the total of the graphite and the material which contains silicon and oxygen as the constituent elements is assumed to be 100 percent by mass, the rate of the material which contains silicon and oxygen as the constituent elements is set to 3 to 20 percent by mass. In addition, in the following Patent Documents 2 and 3, although the use of silicon and/or the like as the negative electrode active material has been suggested, a particular example in which silicon and/or the like is used has not been disclosed at all.

### CITATION LIST

### Patent Document

Patent Document 1: Japanese Published Unexamined Patent Application No. 2010-199077

Patent Document 2: Japanese Published Unexamined Patent Application No. 2011-192402

Patent Document 3: Japanese Published Unexamined Patent Application No. 2011-182402

Patent Document 4: Japanese Published Unexamined Patent Application No. 2010-212228

Patent Document 5: Japanese Patent No. 3969164 Patent Document 6: Japanese Published Unexamined Patent Application No. 2005-056830

### SUMMARY OF INVENTION

### Technical Problem

However, in a nonaqueous electrolyte secondary battery in which a foreign element-added lithium cobalt composite oxide is used as the positive electrode active material, and a material containing silicon and oxygen as the constituent elements is used as the negative electrode active material, when charge and discharge are repeatedly performed at a high charge end voltage of 4.4 to 4.6 V with reference to lithium, degradation in cycle characteristics at a high temperature and increase in battery thickness due to promotion of gas generation disadvantageously occur.

According to one aspect of the present invention, when a lactone and another component are used in combination as the nonaqueous solvent of the nonaqueous electrolyte, even in the case in which a foreign element-added lithium cobalt composite oxide is used as the positive electrode active material, a material containing silicon and oxygen as the constituent elements is used as the negative electrode active material, and the charge end voltage is set to 4.4 to 4.6 V with reference to lithium, a nonaqueous electrolyte secondary battery can be provided which has excellent cycle characteristics at a high temperature, which suppresses gas generation, and which has a small increase in battery thickness.

In addition, the above Patent Document 5 has suggested that PC and γ-butyrolactone each functioning as the nonaqueous solvent of the nonaqueous electrolyte are excellent in heat stability, and although those solvents are liable to react with a graphite negative electrode active material, this reaction may be suppressed by a negative electrode coating film additive, such as VC. However, above Patent Document 5 has not suggested at all the use of γ-butyrolactone together with a positive electrode active material containing a foreign element-added lithium cobalt composite oxide and a negative electrode active material containing silicon; the setting of the charge end voltage to high, such as 4.4 to 4.6 V, with reference to lithium; and the degree of gas generation at a high charge end voltage.

In addition, the above Patent Document 6 has suggested that as the positive electrode active material, a foreign element-added lithium cobalt composite oxide is used, and as the nonaqueous solvent of the nonaqueous electrolyte, a solvent containing 10 percent by volume or more of γ-butyrolactone is used. However, in a nonaqueous electrolyte solution in which the nonaqueous solvent only contains γ-butyrolactone and a cyclic carbonate such as EC, the viscosity is remarkably increased, and in view of solution pouring property and charge discharge characteristics, this nonaqueous electrolyte solution may not be practically applied to a nonaqueous electrolyte secondary battery having a high energy density. In addition, in a nonaqueous electrolyte secondary battery in which a nonaqueous electrolyte containing 10 percent by volume or more of γ-butyrolactone is used, long-term charge/discharge cycle characteristics are seriously degraded. In addition, the above Patent Document 6 has not disclosed at all the use of a material containing silicon as the negative electrode active material; the setting of the charge end voltage to high, such as 4.4 to 4.6 V, with reference to lithium; and the degree of gas generation at a high charge end voltage.

### Solution to Problem

According to one embodiment of the present invention, there is provided a nonaqueous electrolyte secondary battery comprising:

a positive electrode including a positive electrode active material which absorbs and releases lithium ions;

a negative electrode including a negative electrode active material which absorbs and releases lithium ions;

a separator; and a nonaqueous electrolyte,

the positive electrode active material including a lithium cobalt composite oxide which contains at least aluminum (Al) and magnesium (Mg),

the negative electrode active material including at least one of metal silicon (Si) and a silicon oxide represented by SiOₓ (0.5≦x<1.6), and

the nonaqueous electrolyte containing as a nonaqueous solvent, EC, a lactone, and FEC.

### Advantageous Effects of Invention

According to the nonaqueous electrolyte secondary battery of one embodiment of the present invention, even if the charge end voltage of the positive electrode is set to high, such as 4.4 to 4.6 V, with reference to lithium, a nonaqueous electrolyte secondary battery which has a long cycle life at a high temperature, which suppresses gas generation, and which has a small battery swelling can be obtained.

### BRIEF DESCRIPTION OF DRAWINGS

FIG. 1 is a perspective view of a square nonaqueous electrolyte secondary battery according to one embodiment.

### DESCRIPTION OF EMBODIMENTS

Hereinafter, embodiments of the present invention will be described in detail. However, the following embodiments will be described by way of example to facilitate the understanding of the technical scope of the present invention and are not intended to specify the present invention. The present invention may also be equally applied to various changes and modifications performed without departing from the technical scope disclosed in the claims. First, a method for manufacturing a square nonaqueous electrolyte secondary battery used in each of Experimental Examples 1 to 6 will be described.

[Formation of Positive Electrode Plate]

A positive electrode plate was formed as described below. In a synthesis of cobalt carbonate, with respect to cobalt, 0.1 percent by mole of zirconium (Zr), 1 percent by mole of magnesium (Mg), and 1 percent by mole of aluminum (Al) were co-precipitated and were then thermally decomposed to form a zirconium, magnesium, aluminum-containing tricobalt tetraoxide, and this product thus obtained was used as a cobalt source. Lithium carbonate (Li₂CO₃) functioning as a lithium source was mixed with the above cobalt source and was then calcined at 850° C. for 20 hours, so that a zirconium, magnesium, aluminum-containing lithium cobalt composite oxide (LiCO_{0.979}Zr_{0.001}Mg_{0.01}Al_{0.01}O₂) was obtained. This composite oxide was pulverized using a mortar to have an average grain diameter of 14 μm. A positive electrode active material formed from this zirconium, magnesium, aluminum-containing lithium cobalt composite oxide was called a “positive electrode active material A”. In addition, the positive electrode active material A was used as the positive electrode active material of the nonaqueous electrolyte secondary battery of each of Experimental Examples 1, 2, and 4 to 6.

In addition, a positive electrode active material formed of a lithium cobalt composite oxide (LiCoO₂) was prepared in a manner similar that described above except that no foreign elements were added in the synthesis of cobalt carbonate. The positive electrode active material formed of this lithium cobalt composite oxide was called a “positive electrode active material B”. In addition, the positive electrode active material B was used as the positive electrode active material of the nonaqueous electrolyte secondary battery of Experimental Example 3.

After a mixture was formed by mixing to contain 95 parts by mass of the positive electrode active material A or B powder prepared as described above, 2.5 parts by mass of a carbon powder functioning as an electrically conductive agent, and 2.5 parts by mass of a poly(vinylidene fluoride) (PVdF) powder functioning as a binder, this mixture was mixed with a N-methylpyrrolidone (NMP) solution, so that a slurry was prepared. This slurry was applied to two surfaces of an aluminum foil-made collector having a thickness of 15 μm by a doctor blade method, so that active material mixture layers were formed on the two surfaces of the positive electrode collector. Subsequently, after rolling was performed using compression rollers, a positive electrode plate was formed by cutting to have a predetermined size.

[Formation of Negative Electrode Plate]

(1) Preparation of Silicon-Oxide Negative Electrode

### Active Material

After grains having a composition of SiOₓ (x=1) was pulverized and classified for grain size control to have an average grain diameter of 6 μm, the grains thus obtained was heated to approximately 1,000° C., and the surfaces thereof were covered with carbon by a CVD method in an argon atmosphere. Subsequently, pulverization and classification were performed, so that a silicon-oxide negative electrode active material was prepared.

In addition, whether the effect of the present invention is obtained or not is not determined by the treatment temperature of SiOₓ and/or the presence or absence of the coating treatment with a carbon material, and when the coating treatment is performed with a carbon material, any known method may be used without performing any modification. However, the coating treatment is preferably performed on SiOₓ with a carbon material, and this coating amount is more preferably set to 1 percent by mass or more of the silicon oxide grains including the carbon material. In addition, as for the average grain diameter of SiO, measurement was performed using a laser diffraction type grain distribution measurement apparatus (SALD-2000A manufactured by Shimadzu Corporation). Water was used as a dispersion medium, and the refractive index was set to 1.70-0.01i. As the average grain diameter, a grain diameter at which the cumulative grain amount was 50% on the volume basis was used.

(2) Preparation of Graphite Negative Electrode Active Material

A flaky artificial graphite functioning as a core and a petroleum pitch functioning as a carbon precursor to be formed into an amorphous carbon which coats the surface of the core were prepared. While being heated in an inert gas atmosphere, those materials were mixed together and calcined. Subsequently, by pulverization and classification, graphite having an average grain diameter of 22 μm and having a surface coated with an amorphous carbon was prepared. In addition, graphite having an average grain diameter of 18 to 22 μm is particularly preferably used.

(3) Preparation of Negative Electrode

The graphite and the silicon oxide, each of which was prepared as described above, were mixed together to have a mass ratio of 95:5, and this mixture was used as the negative electrode active material. This negative electrode active material, a carboxymethyl cellulose (CMC) functioning as a thickener, and a styrene butadiene rubber (SBR) functioning as a binder were dispersed in water so that the mass ratio of the negative electrode active material (graphite+SiO), the CMC, and the SBR was 97:1.5:1.5, and hence, a negative electrode mixture slurry was prepared. This negative electrode mixture slurry was applied to two surface of a copper-made collector having a thickness of 8 μm by a doctor blade method to form negative electrode active material mixture layers, and after moisture was removed by drying, rolling was performed using compression rollers to form a plate having a predetermined thickness. Subsequently, cutting was performed into a predetermined size, so that a negative electrode plate commonly used in Experimental Examples 1 to 6 was formed.

[Preparation of Nonaqueous Electrolyte Solution]

As a nonaqueous solvent, ethylene carbonate (EC), propylene carbonate (PC), γ-butyrolactone (GBL), ethyl methyl carbonate (EMC), and diethyl carbonate (DEC) were prepared, and on the volume basis at 25° C., a mixture of EC, EMC, and DEC at a ratio of 30:35:35 (Experimental Example 1), a mixture of EC, PC, EMC, and DEC at a ratio of 20:10:35:35 (Experimental Examples 2 and 3), a mixture of EC, GBL, EMC, and DEC at a ratio of 25:5:35:35 (Experimental Examples 4 and 6), and a mixture of EC, GBL, EMC, and DEC at a ratio of 20:10:35:35 (Experimental Example 5) were prepared. Furthermore, as a nonaqueous electrolyte solution, a mixture was used in which lithium hexafluorophosphate (LiPF₆) was dissolved in the nonaqueous solvent to have a concentration of 1 mol/L, and vinylene carbonate (VC), adiponitrile (AdpCN), and fluoroethylene carbonate (FEC) were added to the total nonaqueous electrolyte solution so as to have concentrations of 2.0 percent by mass, 1.0 percent by mass, and 1.0 percent by mass, respectively (other than Experimental Example 3). The compositions of the nonaqueous electrolyte solutions of Experimental Examples 1 to 6 are collectively shown in Table 1 other than the electrolyte salts.

[Formation of Nonaqueous Electrolyte Secondary Battery]

The positive electrode plate and the negative electrode plate formed as described above were wound with a separator of a polyethylene-made porous film interposed therebetween, and a polypropylene-made tape was adhered to the outermost circumference, so that a cylindrical wound electrode assembly was formed. Next, this electrode assembly was pressed to form a flat wound electrode assembly. This flat wound electrode assembly was inserted into a prismatic aluminum alloy-made outer can, and this prismatic outer can was sealed with a sealing body having a solution pouring port. In addition, after the nonaqueous electrolyte solution prepared as described above was supplied through the solution pouring port, the solution pouring port was sealed. As described above, a prismatic nonaqueous electrolyte secondary battery having a height of 62 mm, a width of 44 mm, and a rated thickness of 4.8 mm was formed. In addition, the rated discharge capacity of the nonaqueous electrolyte secondary battery thus formed was 1,700 mAh.

[Structure of Nonaqueous Electrolyte Secondary Battery]

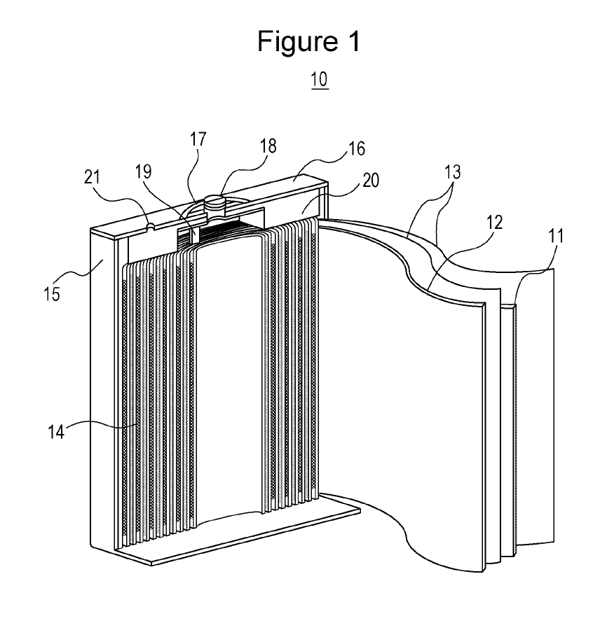

Next, the structure of the square nonaqueous electrolyte secondary battery common in Experimental Examples 1 to 6 will be described with reference to FIG. 1. A nonaqueous electrolyte secondary battery 10 is configured so that a flat wound electrode assembly 14 formed by winding a positive electrode plate 11 and a negative electrode plate 12 with a separator 13 interposed therebetween is received in a prismatic battery outer can 15 and so that the battery outer can 15 is sealed by a sealing plate 16. The wound electrode assembly 14 is formed by winding so that the positive electrode plate 11 is located and exposed at the outermost circumference, and the positive electrode plate 11 exposed at the outermost circumference is directly in contact with the inside surface of the battery outer can 15 also functioning as a positive electrode terminal and is electrically connected thereto. In addition, the negative electrode plate 12 is electrically connected through a collector 19 to a negative electrode terminal 18 formed at the center of the sealing plate 16 and fitted thereto with an insulating body 17 interposed therebetween.

In addition, since the battery outer can 15 is electrically connected to the positive electrode plate 11, in order to prevent short circuit between the negative electrode plate 12 and the battery outer package can 15, an insulating spacer 20 is inserted between the top end of the wound electrode body 14 and the sealing plate 16, so that the negative electrode plate 12 and the battery outer package can 15 are placed in an electrically insulating state. This prismatic nonaqueous electrolyte secondary battery 10 is formed in such a way that after the wound electrode body 14 is inserted in the battery outer can 15, and the sealing plate 16 is laser-welded to an opening portion of the battery outer package can 15, the nonaqueous electrolyte solution is poured through an electrolyte solution pouring port 21, and the electrolyte solution pouring port 21 is then sealed.

[Charge/Discharge Test]

The following charge/discharge test was performed on the prismatic nonaqueous electrolyte secondary battery of each of Experimental Examples 1 to 6, and the capacity retention rate after high-temperature charge/discharge cycles was measured. First, at 45° C., charge was performed at a constant current of 1 It (=1,700 mA) until the battery voltage reached 4.35 V (the positive electrode potential was 4.45 V with reference to lithium), and after the battery voltage reached 4.35 V, charge was performed at a constant voltage of 4.35 V until the current reached 1/50 It (=34 mA). In addition, discharge was performed at a constant current of 1 It (1,700 mA) until the battery voltage reached 3.00 V, and the electrical quantity passing in this step was obtained as a first discharge capacity.

Charge and discharge were repeatedly performed under the same conditions as described above, and a 500th discharge capacity was measured, and the capacity retention rate of the square nonaqueous electrolyte secondary battery of each of Experimental Examples 1 to 6 was obtained by the following calculation equation. The results are collectively shown in Table 1.

Capacity retention rate (%)=(500th discharge capacity/first discharge capacity)×100

[Trickle Charge Test]

In order to evaluate the swelling of a battery main body, a trickle charge test was performed on the square nonaqueous electrolyte secondary battery of each of Experimental Examples 1 to 6 under the following charge conditions, and the difference in thickness of the battery main body before and after this trickle charge test was measured. The trickle charge test was performed at 45° C. in such a way that charge was performed at a constant current of 1 It (=1,700 mA) until the battery voltage reached 4.35 V (the positive electrode potential was 4.45 V with reference to lithium), and after the battery voltage reached 4.35 V, charge was continued at a constant voltage of 4.35 V until the current reached 0 mA. The thickness at this stage was measured as an initial thickness. Subsequently, a constant voltage of 4.35 V was continuously applied for 5 weeks, and the thickness after 5 weeks was measured. The difference between the initial thickness and the battery thickness after 5 weeks was obtained, and this difference was regarded as the increase in battery thickness after the trickle cycles. The results are collectively shown in Table 1.

TABLE 1

| | Positive | | | | | | | | | | |
|---|---|---|---|---|---|---|---|---|---|---|---|
| | Electrode | EC | PC | GBL | EMC | DEC | VC | FEC | AN | Capacity | Increase |
| | Active | (vol | (vol | (vol | (vol | (vol | (mass | (mass | (mass | Retention | in Battery |
| | Material | %) | %) | %) | %) | %) | %) | %) | %) | Rate | Thickness |
| Experimental | A | 30 | 0 | 0 | 35 | 35 | 2.5 | 1.0 | 1.0 | 81.4% | +2.0 mm |
| Example 1 | | | | | | | | | | | |
| Experimental | A | 20 | 10 | 0 | 35 | 35 | 2.5 | 1.0 | 1.0 | 70.6% | +1.4 mm |
| Example 2 | | | | | | | | | | | |
| Experimental | A | 20 | 10 | 0 | 35 | 35 | 2.5 | 0 | 1.0 | 30% or | +1.2 mm |
| Example 3 | | | | | | | | | | less | |
| Experimental | B | 25 | 0 | 5 | 35 | 35 | 2.5 | 1.0 | 1.0 | 30% or | +1.8 mm |
| Example 4 | | | | | | | | | | less | |
| Experimental | A | 20 | 0 | 10 | 35 | 35 | 2.5 | 1.0 | 1.0 | 77.5% | +0.1 mm |
| Example 5 | | | | | | | | | | | |
| Experimental | A | 25 | 0 | 5 | 35 | 35 | 2.5 | 1.0 | 1.0 | 79.6% | +0.2 mm |
| Example 6 | | | | | | | | | | | |

A: LiCo_{0.979}Zr_{0.001}Mg_{0.01}Al_{0.01}O₂
B: LiCoO₂
EC: Ethylene Carbonate
PC: Propylene Carbonate
GBL: γ-Butyrolactone
EMC: Ethyl Methyl Carbonate
DEC: Diethyl Carbonate
FEC: Fluoroethylene Carbonate
AN: Adiponitrile

From the results shown in Table 1, the following can be found. That is, when the results of Experimental Example 1 are compared to the results of Experimental Example 2, in each of which the positive electrode active material A is used, although the capacity retention rate of the battery of Experimental Example 2 is lower than that of the battery of Experimental Example 1, the increase in battery thickness after the trickle charge is smaller. Since the difference in structure between the battery of Experimental Example 1 and the battery of Experimental Example 2 is only that whether EC is only used as a cyclic carbonate (Experimental Example 1) or EC is partially substituted by PC (Experimental Example 2), it is found that although PC functioning as a cyclic carbonate decreases the capacity retention rate as compared to that obtained by EC, the gas generation is suppressed.

When the results of Experimental Example 2 are compared to the results of Experimental Example 3, in each of which the positive electrode active material A is used as in the case described above, although the capacity retention rate of the battery of Experimental Example 3 is remarkably lower than that of the battery of Experimental Example 2, the increase in battery thickness after the trickle charge is smaller. Since the difference in structure between the battery of Experimental Example 2 and the battery of Experimental Example 3 is only that whether FEC is contained (Experimental Example 2) or not (Experimental Example 3), it is found that although the addition of FEC is significantly effective to increase the capacity retention rate, the gas generation is slightly promoted.

When the results of Experimental Example 1 are compared to those of Experimental Examples 5 and 6, in each of which the positive electrode active material A is used as in the case described above, although the capacity retention rates of the batteries of Experimental Examples 5 and 6 are each slightly low, the increase in battery thickness after the trickle charge is significantly small. Since the difference in structure between the battery of Experimental Example 1 and the battery of each of Experimental Examples 5 and 6 is only that whether EC is only used as a cyclic carbonate (Experimental Example 1) or EC is partially substituted by GBL (Experimental Examples 5 and 6), it is found that the addition of GBL as a cyclic carbonate is significantly effective to maintain the capacity retention rate and to suppress the gas generation.

In the case described above, from the results of Experimental Examples 1 and 6, it is found that when EC is partially substituted even by a slight amount of GBL, the capacity retention rate is not so much decreased, and the increase in battery thickness can be made smaller; hence, the addition amount of GBL may be set to at least 0.1 percent by volume. When the addition amount of GBL is excessively small, the effect of the addition of GBL may not be obtained in some cases. In addition, when the results of Experimental Examples 5 and 6 are compared to each other, it is found that when the addition amount of GBL is 10 percent by volume (Experimental Example 5), although the increase in battery thickness is smaller than that obtained when the addition amount of GBL is 5 percent by volume (Experimental Example 6), the capacity retention rate is decreased. In consideration of the increase in viscosity when the addition amount of GBL is increased, the addition amount of GBL is preferably at most 15 percent by volume. That is, the addition amount of GBL is preferably 0.1 to 15 percent by volume and further preferably 1 to 10 percent by volume.

In addition, when the results of Experimental Example 6 in which the positive electrode active material A is used are compared to those of Experimental Example 4 in which the positive electrode active material B is used, the capacity retention rate of the battery of Experimental Example 4 is remarkably degraded, and in addition, the increase in battery thickness thereof is also seriously large. Since the difference in structure between the battery of Experimental Example 6 and the battery of Experimental Example 4 is only that whether the positive electrode active material A is used (Experimental Example 6) or the positive electrode active material B is used (Experimental Example 4), it is found that when the positive electrode active material A is used, that is, when a lithium cobalt composite oxide containing at least both of Al and Mg is used as the positive electrode active material, the effect caused by partially substituting EC functioning as a cyclic carbonate by GBL can be obtained.

It has been construed that the effects of Experimental Examples 1 to 6 as described above are obtained by the following reasons. In a nonaqueous electrolyte secondary battery, it has been known that in order to suppress the decomposition of a nonaqueous solvent and to maintain the cycle characteristics, EC is required when graphite is contained as the negative electrode active material, and FEC is required when Si is contained as the negative electrode active material. Since EC and FEC are each decomposed on the surface of the negative electrode active material during initial charge and each form a coating film called a solid electrolyte interface (SEI) on the surface described above, a nonaqueous solvent present around this SEI is prevented from coming close and intruding into the negative electrode active material in association with the transportation of lithium ions, and as a result, a reduction decomposition of the nonaqueous solvent is suppressed.

However, as apparent from the results of Experimental Example 1, EC and FEC are both decomposed in a high charge voltage/high temperature environment, and gases are generated thereby. As apparent from the results of Experimental Examples 5 and 6, when EC is partially substituted by GBL, although the capacity retention rate is slightly decreased, the phenomenon as described above, that is, the gas generation, can be substantially prevented. The reason for this is believed that although EC and FEC are each oxidatively decomposed on the surface of the positive electrode active material, when GBL is present, GBL is preferentially decomposed on the surface of the positive electrode active material and forms a stable coating film, and hence EC and FEC are each not likely to be oxidatively decomposed on the surface of the positive electrode active material.

The content of FEC is set to preferably 0.1 to 20 percent by mass and more preferably 0.5 to 10 percent by mass with respect to the total nonaqueous electrolyte solution. When the content of FEC is less than 0.1 percent by mass, since FEC is lost by decomposition during the initial charge/discharge cycle, the effect of improving the cycle characteristics may not be sufficiently obtained in some cases. When the content of FEC is more than 20 percent by mass, since the amount of gases generated by reduction decomposition and/or thermal decomposition is increased, the battery main body is liable to swell.

The content of EC is preferably 15 to 50 percent by volume and more preferably 20 to 35 percent by volume. When the content of EC is less than 15 percent, since a coating film forming effect on the surface of graphite functioning as the negative electrode active material is small, the cycle characteristics are degraded. When the content of EC is more than 50 percent by volume, since the viscosity of the nonaqueous electrolyte solution is excessively increased, the solution pouring property is degraded.

In addition, in the above embodiment, although the example is shown in which as the positive electrode active material, the zirconium, magnesium, aluminum-containing lithium cobalt composite oxide (LiCo_{0.979}Zr_{0.001}Mg_{0.01}Al_{0.01}O₂) is used, if a lithium cobalt composite oxide simultaneously containing aluminum and magnesium is used, an effect similar to that described above can also be obtained in the present invention. Hence, besides the zirconium, magnesium, aluminum-containing lithium cobalt composite oxide (LiCo_{0.979}Zr_{0.001}Mg_{0.01}Al_{0.01}O₂), for example, a layered manganese lithium nickelate containing cobalt (LiNi_{0.33}Co_{0.33}Mn_{0.34}O₂) may also be contained. In addition, since a layered manganese lithium nickelate containing cobalt is excellent in thermal stability, when a zirconium, magnesium, aluminum-containing lithium cobalt composite oxide is used together therewith, the stability can be enhanced.

In addition, in the above Experimental Examples, although the case in which γ-butyrolactone is used as a lactone is described by way of example, besides γ-butyrolactone, for example, γ-valerolactone, α-acetyl-γ-butyrolactone, β-butyrolactone, γ-valerolactone, δ-valerolactone, γ-hexanolactone, δ-hexalactone, ε-caprolactone, γ-caprolactone, δ-caprolactone, dimethyl-ε-caprolactone, γ-nonalactone, γ-decalactone, methyl-γ-decalactone, γ-undecalactone, γ-dodecalactone, δ-dodecalactone, and ε-dodecalactone may also be used.

In addition, in the above Experimental Examples 1 to 6, in order to easily confirm the increase in battery thickness, although the square nonaqueous electrolyte secondary battery is described by way of example, the present invention may also be applied to a cylindrical nonaqueous electrolyte secondary battery using a metal outer package can and a laminate nonaqueous electrolyte secondary battery.

### REFERENCE SIGNS LIST

10 nonaqueous electrolyte secondary battery, 11 positive electrode plate, 12 negative electrode plate, 13 separator, 14 flat wound electrode body, 15 square battery outer package can, 16 sealing plate, 17 insulating body, 18 negative electrode terminal, 19 collector, 20 insulating spacer, 21 electrolyte solution pouring port

1. A nonaqueous electrolyte secondary battery comprising:
a positive electrode including a positive electrode active material which absorbs and releases lithium ions;
a negative electrode including a negative electrode active material which absorbs and releases lithium ions;
a separator; and a nonaqueous electrolyte,
wherein the positive electrode active material includes a lithium cobalt composite oxide containing at least aluminum (Al) and magnesium (Mg),
the negative electrode active material includes at least one of metal silicon (Si) and a silicon oxide represented by SiOₓ (0.5≦x<1.6), and
the nonaqueous electrolyte contains as a nonaqueous solvent, ethylene carbonate, a lactone, and fluoroethylene carbonate.

2. The nonaqueous electrolyte secondary battery according to claim 1, wherein the nonaqueous electrolyte solution contains γ-butyrolactone as the lactone.

3. The nonaqueous electrolyte secondary battery according to claim 2, wherein the content of the γ-butyrolactone is 0.1 to 15 percent by volume with respect to the total nonaqueous solvent.
